(19) United States
(12) Patent Application Publication
(10) Pub. No.: US 2023/0281269 A1
(43) Pub. Date: Sep. 7, 2023

(54) MATRIX INDEX INFORMATION GENERATION METHOD, MATRIX PROCESSING METHOD USING MATRIX INDEX INFORMATION, AND DEVICE

(71) Applicant: INDUSTRY ACADEMY COOPERATION FOUNDATION OF SEJONG UNIVERSITY, Seoul (KR)

(72) Inventors: Gi-Ho PARK, Seoul (KR); Chi Won HAN, Seoul (KR); Min Kwan KEE, Seoul (KR)

(21) Appl. No.: 18/002,393

(22) PCT Filed: Jun. 17, 2021
(86) PCT No.: PCT/KR2021/007578

§ 371 Date: Apr. 17, 2023

(30) Foreign Application Priority Data
Jun. 30, 2020 (KR) 10-2020-0079782
Aug. 14, 2020 (KR) 10-2020-0102311

(51) Int. Cl. G06F 17/16; G06N 3/048

(52) U.S. Cl. CPC G06F 17/16; G06N 3/048

(57) ABSTRACT

Disclosed are a method for generating matrix index information about a target matrix including a sparse matrix, and a method for processing a matrix using matrix index information. The disclosed matrix index information generation method comprises the steps of: confirming elements of a target matrix; and generating a bit stream which includes one or more bits each allocated to each of the elements and indicating position information about the element within the target matrix.

### TECHNICAL FIELD

The present disclosure relates to a method of generating index information of a matrix, and a method and apparatus for processing a matrix using index information of the matrix.

### BACKGROUND ART

With the recent development of neural network models, such as convolutional neural network (CNN) models used in service sectors such as image recognition and the like, the depth or the like of layers to be processed by a neural network model is increasing. Due to such factors, the number of parameters, such as a weight matrix of a neural network model, has increased, and high memory overhead has emerged as an important issue.

As a method of resolving this issue, utilizing the fact that a pruning technique performed to address an overfitting problem of a neural network model converts a weight matrix into a sparse matrix, research on a method of indexing a matrix by which operation of a sparse matrix is efficiently performable has been conducted.

As a method of indexing a sparse matrix, compressed sparse row (CSR) is widely used, but there are shortcomings that a sparse matrix indexing method such as CSR, when applied in units of weight matrices, requires operations for identifying index size and position and considerable overhead occurs in expressing a matrix having low sparsity, that is, a small number of non-zero elements.

### DISCLOSURE

### Technical Problem

The present disclosure is directed to providing a method of generating matrix index information about a target matrix including a sparse matrix.

The present disclosure is directed to providing a method and apparatus for processing a matrix that are capable of loading information about a target matrix from a memory using matrix index information about the target matrix and processing the target matrix.

### Technical Solution

One aspect of the present disclosure provides a method of generating matrix index information, the method including: identifying elements of a target matrix; and generating a bit string including one or more bits each allocated to one of the elements and representing position information of the element in the target matrix.

Another aspect of the present disclosure provides a method of processing a matrix using matrix index information, the method including: loading a non-zero element value of a first target matrix from a memory using matrix index information of the first target matrix; and transferring the loaded data to a processing element, wherein the matrix index information includes information about the number of non-zero elements of the first target matrix and position information of the non-zero elements in the first target matrix.

Another aspect of the present disclosure provides an apparatus for processing a matrix using matrix index information, the method including: a bit string generator configured to generate at least one bit string including bits each allocated to one of elements of a target matrix and representing position information of the element in the target matrix; a data loader configured to load a value of a non-zero element among the elements from a memory using the bit string; and an operator configured to perform an operation on the target matrix using the loaded data.

### Advantageous Effects

According to an embodiment of the present disclosure, even when the sparsity of a matrix decreases, the size of matrix index information can be maintained constant, and thus the memory usage can be reduced.

In addition, according to one embodiment of the present disclosure, since number information and position information about all elements of a target matrix are included in matrix index information, information about the target matrix can be obtained with only a single access to a memory for the matrix index information, and thus the number of memory accesses for obtaining information about the target matrix can be reduced.

### DESCRIPTION OF DRAWINGS

FIG. 1 is a diagram for describing compressed sparse row (CSR) which is one of matrix indexing methods.

FIG. 2 is a diagram for describing a method of generating matrix index information according to an embodiment of the present disclosure.

FIG. 3 is a diagram illustrating matrix index information according to an embodiment of the present disclosure.

FIGS. 4A and 4B show diagrams for describing the size of matrix index information according to an embodiment of the present disclosure.

FIG. 5 is a diagram for describing an apparatus for processing a matrix using matrix index information according to an embodiment of the present disclosure.

FIG. 6 is a diagram for describing a method of processing a matrix using matrix index information according to an embodiment of the present disclosure.

FIG. 7 is a diagram illustrating an example of matrix index information stored in a memory.

FIG. 8 is a diagram for describing a method of processing a matrix using matrix index information according to another embodiment of the present disclosure.

### MODES OF THE INVENTION

While embodiments according to the concept of the present disclosure are subject to various modifications and alternative forms, specific embodiments thereof are shown by way of example in the accompanying drawings and will herein be described in detail. However, it should be understood that there is no intent to limit the present disclosure to the particular forms disclosed, rather the present disclosure is to cover all modifications, equivalents, and alternatives falling within the spirit and scope of the present disclosure. In the drawings, like numerals refer to like functionality throughout the several views.

Hereinafter, embodiments according to the present disclosure will be described in detail with reference to the accompanying drawings.

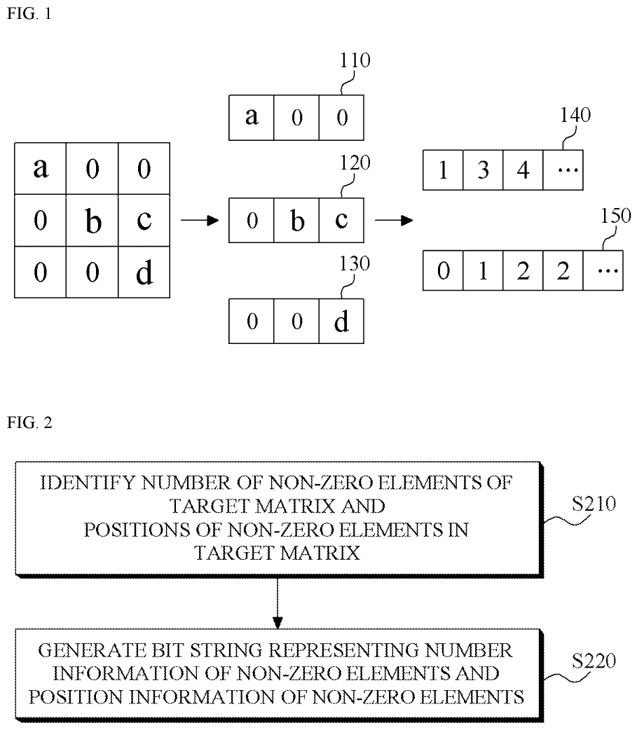

FIG. 1 is a diagram for describing compressed sparse row (CSR) which is one of matrix indexing methods.

According to CSR, indexing is performed in units of rows of a matrix. Referring to FIG. 1, given a 3×3 size target matrix 100 including zeros in addition to non-zero elements a, b, c, and d, each of the three rows is subject to indexing according to CSR, and index information for rows and columns is generated. The index information for rows includes cumulative information about the number of non-zero elements for each row, and the index information for columns includes information about the positions of non-zero elements in each row.

In a first row 110, there is one non-zero element a, and in a second row 120, there are two non-zero elements b and c. In a third row 130, there is one non-zero element d. Therefore, index information 140 for rows includes an index of 1 corresponding to the number of the non-zero elements of the first row 110, an index of 3 corresponding to a cumulative value of the number of the non-zero elements of the first row 110 and the number of the non-zero elements of the second row 120, and an index of 4 corresponding to a value obtained by adding the number of the non-zero elements of the third row 130 to the cumulative number of the non-zero elements of the first and second rows 110 and 120.

In the first row 110, the non-zero element a is located in a first column, and in the second row 120, the non-zero elements b and c are located in second and third columns. Finally, in the third row 130, the non-zero element d is located in the third column. Accordingly, index information 150 for columns includes an index of 0 corresponding to the position of the first column in the first row 110, indexes of 1 and 2 corresponding to the positions of the second and third columns in the second row 120, and an index of 2 corresponding to the position of the third column in the third row 130.

Since CSR is a matrix indexing method for targeting a matrix with very high sparsity, there is a problem that the size of matrix index information increases when the sparsity of the target matrix is small, that is, when the number of non-zero elements is large in the target matrix. In addition, in the case of CSR, in order to obtain information about a target matrix using matrix index information, as many memory accesses as the number of rows of the target matrix is required. Accordingly, the present disclosure proposes a method of generating matrix index information that is capable of keeping the size of matrix index information constant even when the sparsity of a target matrix decreases and reducing the number of memory accesses for obtaining information about the target matrix. In addition, the present disclosure proposes a method of processing a matrix using matrix index information.

One embodiment of the present disclosure is implemented to identify elements of a target matrix, and generate a bit string including one or more bits each allocated to one of the elements and representing position information of the element in the target matrix, i.e., matrix index information. That is, in the embodiment of the present disclosure, a bit string including bits respectively allocated to elements of a target matrix and respectively corresponding to the elements is generated, and each bit in the bit string represents the position of the element in the target matrix.

Matrix index information according to an embodiment may include a bit string representing information about the number of non-zero elements among elements of a target matrix and a bit string representing position information about all elements of the target matrix.

A method of generating matrix index information and a method of processing a matrix using matrix index information according to an embodiment of the present disclosure may be performed by an apparatus for processing a matrix. The apparatus for processing a matrix may be a semiconductor chip for computation, such as a processor or a deep learning accelerator, or a computing device including such a semiconductor chip for computation.

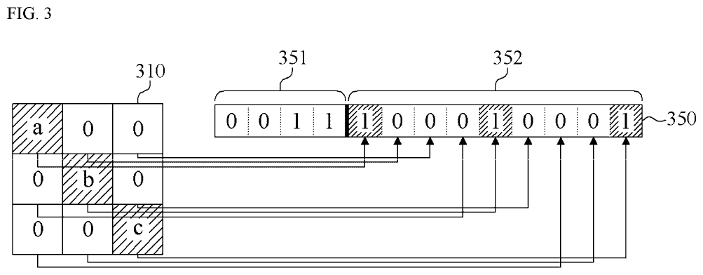

FIG. 2 is a diagram for describing a method of generating matrix index information according to an embodiment of the present disclosure, and FIG. 3 is a diagram illustrating matrix index information according to an embodiment of the present disclosure.

Referring to FIG. 2, the apparatus for processing a matrix according to the embodiment of the present disclosure identifies the number of non-zero elements of a target matrix and the positions of the non-zero elements in the target matrix (S210) and generates a bit string representing information about the number of the non-zero elements and position information of the non-zero elements, that is, matrix index information (S220). As an example, the target matrix may be a weight matrix including weight values of an artificial neural network.

Referring to FIG. 3, matrix index information 350 according to an embodiment of the present disclosure may be expressed in the form of a bit string, and include a first bit string 351 representing information about the number of non-zero elements and a second bit string 352 representing information about the positions of the non-zero elements.

As shown in FIG. 3, given a target matrix 310 having a size of 3×3 and including zeros in addition to non-zero elements a, b, and c, the number of non-zero elements a, b, and c is three, and thus a first bit string 351 has a bit value ‘0011’ corresponding to 3.

A second bit string 352 includes bits corresponding to respective positions of elements in the target matrix. That is, each bit of the second bit string 352 corresponds to the position of each element in the target matrix 310. In the example shown in FIG. 3, a bit corresponding to the position of the non-zero element ‘a’ disposed in the first row and the first column of the target matrix 310 is the most significant bit of the second bit string 352, and a bit corresponding to the position of the non-zero element ‘b’ disposed in the second row and the second column of the target matrix 310 is a bit located in the middle of the second bit string 352. In addition, a bit corresponding to the position of the non-zero element ‘c’ disposed in the third row and the third column of the target matrix 310 is the least significant bit of the second bit string 352.

The number of bits included in the second bit string 352 may be greater than or equal to the number of elements in the target matrix, and in the example of FIG. 3, since the number of elements in the target matrix is nine, nine bits are used in the second bit string 352.

In addition, in the second bit string 352, a bit value corresponding to the position of a zero element of the target matrix 310 and a bit value corresponding to the position of a non-zero element are allocated differently from each other. Therefore, by checking the bit values of the second bit string 352, a non-zero element of the target matrix 310 may be identified. As shown in FIG. 3, a value of 0 may be allocated as a bit value corresponding to the position of a zero element, and a value of 1 may be allocated as a bit value corresponding to the position of a non-zero element.

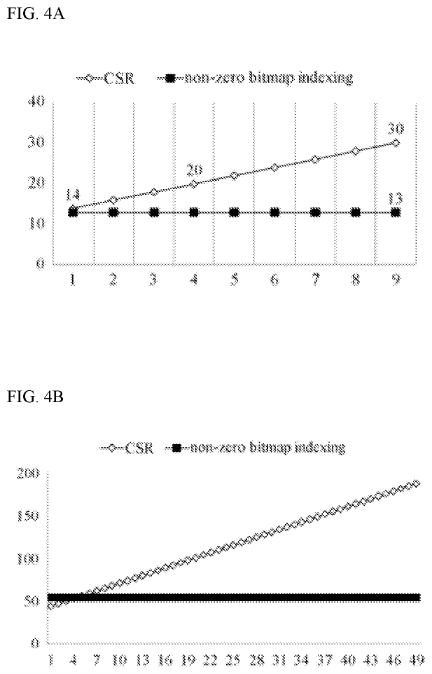

FIGS. 4A and 4B show diagrams for describing the size of matrix index information according to an embodiment of the present disclosure, which are graphs for comparing the size corresponding to the number of non-zero elements with the size of matrix index information generated according to the CSR method.

FIG. 4A is a graph for comparing the sizes of matrix index information in a 3×3 matrix, and FIG. 4B is a graph for comparing the sizes of matrix index information in a 7×7 matrix. In FIGS. 4A and 4B, the X axis represents the number of non-zero elements, and the Y axis represents the size of matrix index information.

Referring to FIGS. 4A and 4B, it can be seen that the size of matrix index information according to an embodiment of the present disclosure (non-zero bitmap indexing) is maintained constant even when the number of non-zero elements increases, whereas the size of matrix index information according to the CSR method linearly increases as the number of non-zero elements is increased.

As a result, according to the embodiment of the present disclosure, even when the sparsity of a matrix decreases, the size of matrix index information may be maintained constant, and thus memory usage may be reduced.

In particular, according to a pruning ratio for an artificial neural network, the sparsity of a weight matrix varies and shows a pattern that the sparsity of a weight matrix decreases as the pruning ratio decreases, and the sparsity pattern may greatly differ for each weight matrix of the pruned model, but even in such an environment, the embodiment of the present disclosure may provide matrix index information with a constant size, and thus memory usage may be reduced.

In addition, according to the embodiment of the present disclosure, since information about the number and the positions of all elements of the target matrix is included in the matrix index information, with only one-time access to the memory for the matrix index information, information about the target matrix may be obtained. Therefore, the number of memory accesses for obtaining information about the target matrix may be reduced.

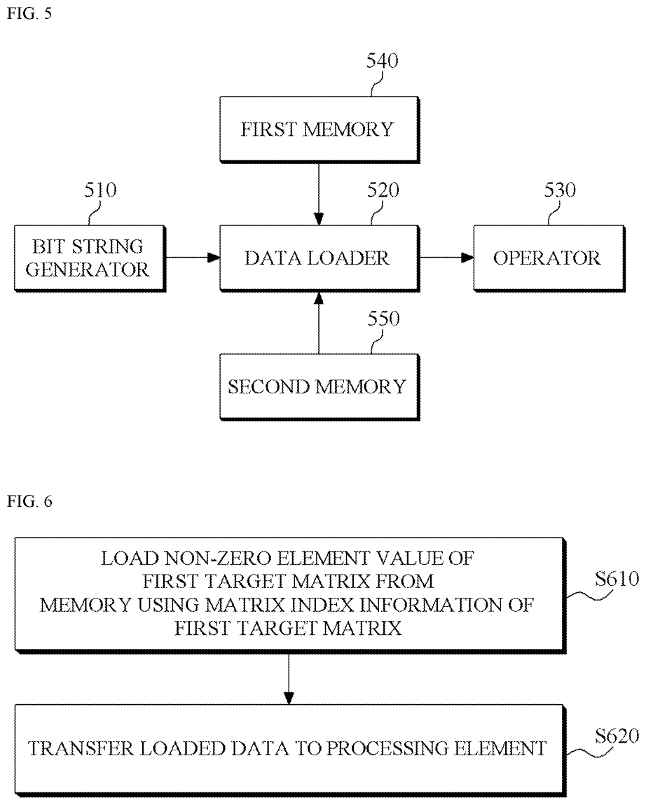

FIG. 5 is a diagram for describing an apparatus for processing a matrix using matrix index information according to an embodiment of the present disclosure.

Referring to FIG. 5, the apparatus for processing a matrix according to the embodiment of the present disclosure includes a bit string generator 510, a data loader 520, and an operator 530. In some embodiments, the apparatus for processing a matrix according to the embodiment of the present disclosure may further include a memory.

The bit string generator 510 generates a bit string representing information about the number of non-zero elements of a first target matrix and information about the positions of the non-zero elements. The bit string may correspond to the matrix index information described with reference to the above embodiment, and the generated bit string and non-zero element values of the target matrix may be stored in a first memory 540.

The data loader 520 may load the non-zero element value of the first target matrix from the memory using the bit string. The data loader 520 may load the non-zero element value of the first target matrix using a memory address value for the non-zero element value stored in the memory.

As an embodiment, memory address values allocated to non-zero element values may be provided in a continuous form according to a preset rule, and to correspond to the order of indices allocated to a target matrix, memory address values for non-zero element values of the target matrix may be allocated in a continuous pattern. Accordingly, the data loader 520 may determine the address values of the non-zero element values of the first target matrix using the number of non-zero element values previously loaded from the memory, and may load the non-zero element values of the first target matrix using the determined memory address values

The operator 530 performs an operation on the first target matrix using the loaded data. For example, the operator 530 may perform an operation on an element value of another, a second target matrix, which is loaded by the data loader 520, and the non-zero element value of the first target matrix. The second target matrix may be stored in a second memory 550. In some embodiments, all element values of the second target matrix may be stored in the second memory 550 or may be stored in the form of matrix index information in the second memory 550, similar to that of the first target matrix.

In addition, as an example, the first target matrix may be a weight matrix including weight values of an artificial neural network, and the second target matrix may be a matrix including activation values of an artificial neural network. That is, the second target matrix may be a matrix that serves as an activation function. Alternatively, in some embodiments, the first target matrix may be a weight matrix for a first layer, and the second target matrix may be a weight matrix for a second layer.

The operator 530 may include a plurality of processing elements for parallel operation, and the non-zero element value of the first target matrix may be allocated to each of the processing elements. Each of the processing elements may perform an operation on the non-zero element value of the first target matrix allocated thereto and an element of the second target matrix.

FIG. 6 is a diagram for describing a method of processing a matrix using matrix index information according to an embodiment of the present disclosure.

Referring to FIG. 6, the apparatus for processing a matrix according to the embodiment of the present disclosure loads a non-zero element value of a first target matrix from a memory using matrix index information of the first target matrix (S610), and transfers the loaded data to a processing element (S620). Here, the matrix index information includes information about the number of non-zero elements of the first target matrix and information about the positions of the non-zero elements in the first target matrix, similar to the matrix index information generated in the above-described embodiment.

In the memory, matrix index information and non-zero element values of a target matrix are stored, and matrix index information and non-zero element values of different sized target matrices may be stored. In this case, each different matrix index information may further include size information of a corresponding target matrix. The size information of the target matrix may be expressed as an index representing the size of rows and columns of the target matrix.

In operation S610, the apparatus for processing a matrix may load an element, among elements of a second target matrix, to be multiplied with the non-zero element of the first target matrix from a memory using the matrix index information of the first target matrix. The loaded element of the second target matrix may be transferred to the processing element in operation S620, and the loaded element may be used for multiplication of the first target matrix.

All elements of the second target matrix may be stored in the memory, and since it is not required to load elements of the second target matrix that are multiplied by zero elements of the first target matrix, the apparatus for processing a matrix may selectively load elements of the second target matrix to be multiplied by the non-zero elements of the first target matrix from the memory.

For example, when the number of non-zero elements in the first target matrix is one and the position of the non-zero element corresponds to the first row and the first column, the apparatus for processing a matrix may load an element positioned at the first row and the first column among the elements of the second target matrix.

Meanwhile, in some embodiments, the apparatus for processing a matrix may load a non-zero element value of a third target matrix from a memory using matrix index information of the third target matrix in operation S610. In this case, the apparatus for processing a matrix may transfer not only the loaded non-zero element value but also matrix index information about the first and third target matrices to the processing element in operation S620.

Alternatively, in some embodiments, the apparatus for processing a matrix may restore the first target matrix using the matrix index information and the non-zero element values of the first target matrix, and transfer the restored first target matrix to the processing element in operation S620. The apparatus for processing a matrix may identify the positions of zero elements of the first target matrix through the matrix index information, and may pad zeros at the positions of the zero elements, thereby restoring the first target matrix.

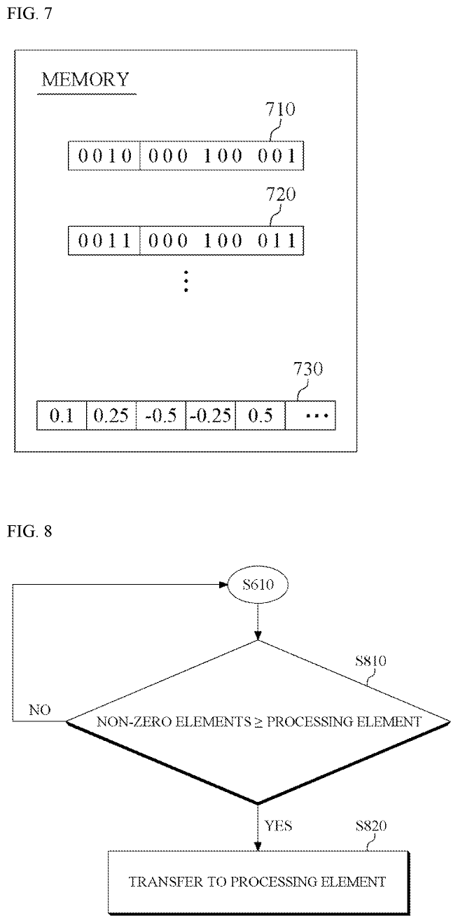

FIG. 7 is a diagram illustrating an example of matrix index information stored in a memory.

The apparatus for processing a matrix according to the embodiment of the present disclosure may load non-zero element values of a first target matrix using memory address values allocated to the non-zero element values of the first target matrix in operation S610. The apparatus for processing a matrix may determine the address values for the non-zero element values of the first target matrix using matrix index information, and load the non-zero element values of the first target matrix using the determined address values.

As described above, the memory address values allocated to the non-zero element values may be provided in a continuous form according to a preset rule, and in this case, the apparatus for processing a matrix may determine the address values of the non-zero element values of the first target matrix using the number of non-zero element values loaded from the memory earlier than the non-zero element values of the first target matrix.

For example, as shown in FIG. 7, in a state in which first matrix index information 710 and second matrix index information 720 and non-zero element values 730 are stored in the memory, while the memory address values for two non-zero element values (0.1, 0.25) loaded earlier than the first target matrix are obtained as N and N+1 through the first matrix index information 710, the apparatus for processing a matrix may determine the memory address values for three element values of the first target matrix as N+2, N+3, and N+4 using the second matrix index information 720. Accordingly, the apparatus for processing a matrix may load non-zero elements of −0.5, −0.25, and 0.5 of the first target matrix corresponding to the memory address values N+2, N+3, and N+4 from the memory.

The apparatus for processing a matrix according to the embodiment of the present disclosure may efficiently load non-zero element values from the memory using a burst mode.

FIG. 8 is a diagram for describing a method of processing a matrix using matrix index information according to another embodiment of the present disclosure.

Referring to FIG. 8, the apparatus for processing a matrix according to the embodiment of the present disclosure compares the number of non-zero elements loaded in operation S610 with the number of processing elements (S810). The apparatus for processing a matrix transfers the loaded non-zero element values to the processing element according to a result of the comparison (S820).

The apparatus for processing a matrix, when the number of non-zero element values loaded in operation S610 is less than the number of processing elements, may not directly transfer the loaded non-zero element values to the processing element, but transfer non-zero element values loaded from the memory subsequent to the non-zero element values of the first target matrix together with the non-zero element values of the first target matrix to the processing element in operation S820.

For example, when the number of processing elements is six and the non-zero element value of the first target matrix loaded at a first point in time is three, the apparatus for processing a matrix may not directly transfer the non-zero element value of the first target matrix to the processing element but, in response to new non-zero element values being loaded at a second point in time subsequent to the first point in time, transfer the non-zero element values of the first target matrix to the processing element together with the new non-zero element values.

Since matrix operations are processed in parallel in several processing elements, the utilization of the processing elements may be increased when values of non-zero elements in a number close to the number of processing elements are transferred to the processing elements at one time. Therefore, the apparatus for processing a matrix according to the embodiment of the present disclosure compares the number of loaded non-zero elements with the number of processing elements, and when the number of loaded non-zero elements is less than the number of processing elements, the loaded non-zero elements are accumulated and transferred to the processing element at one time, thereby increasing the utilization of the processing element.

The technical details described above can be implemented in the form of program instructions executable by a variety of computer devices and may be recorded on a computer readable medium. The computer readable medium may include, alone or in combination, program instructions, data files and data structures. The program instructions recorded on the computer readable medium may be components specially designed for the present disclosure or may be usable by a skilled person in the field of computer software. Computer readable record media include magnetic media such as a hard disk, a floppy disk, or a magnetic tape, optical media such as a compact disc read only memory (CD-ROM) or a digital video disc (DVD), magneto-optical media such as floptical disks, and hardware devices such as a ROM, a random-access memory (RAM), or a flash memory specially designed to store and execute programs. The program instructions include not only machine language code made by a compiler but also high level code that can be used by an interpreter etc., which is executed by a computer. The hardware device may be configured to act as one or more software modules in order to perform the operations of the present disclosure, or vice versa.

While the disclosure has been shown and described with respect to particulars, such as specific components, embodiments, and drawings, the embodiments are used to aid in the understanding of the present disclosure rather than limiting the present disclosure, and those skilled in the art should appreciate that various changes and modifications are possible without departing from the spirit and scope of the disclosure. Therefore, the spirit of the present disclosure is not defined by the above embodiments but by the appended claims of the present disclosure, and the scope of the present disclosure is to cover not only the following claims but also all modifications and equivalents derived from the claims.

1. A method of generating matrix index information, the method comprising:
identifying elements of a target matrix; and
generating a bit string including one or more bits each allocated to one of the elements and representing position information of the elements in the target matrix.

2. The method of claim 1, wherein the bit string includes:
a first bit string representing information about the number of non-zero elements among the elements; and
a second bit string representing the position information.

3. The method of claim 2, wherein the second bit string includes bits each corresponding to one of positions of the elements in the target matrix, and in the second bit string, a bit value corresponding to a position of a zero element in the target matrix and a bit value corresponding to a position of the non-zero elements are different from each other.

4. The method of claim 1, wherein the target matrix is a weight matrix including a weight value of an artificial neural network.

5. A method of processing a matrix using matrix index information, the method comprising:
loading a non-zero element value of a first target matrix from a memory using matrix index information of the first target matrix; and
transferring the loaded data to a processing element,
wherein the matrix index information includes information about the number of non-zero elements of the first target matrix and position information of the non-zero elements in the first target matrix.

6. The method of claim 5, wherein the loading of the non-zero element value from the memory includes loading an element, among elements of a second target matrix, which is to be multiplied by the non-zero elements of the first target matrix from the memory, using the matrix index information.

7. The method of claim 6, wherein the first target matrix is a matrix including a weight value of an artificial neural network, and
the second target matrix includes an activation value of the artificial neural network.

8. The method of claim 5, wherein the loading of the non-zero element value from the memory includes:
determining an address value for the non-zero element value of the first target matrix using the matrix index information; and
loading the non-zero element value of the first target matrix using the address value.

9. The method of claim 8, wherein address values of the memory allocated to non-zero element values are provided in a continuous form according to a preset rule, and
the loading of the non-zero element value from the memory includes:
determining address values for non-zero element values of the first target matrix using the number of non-zero element values loaded from the memory earlier than the non-zero element values of the first target matrix; and
loading the non-zero element value of the first target matrix using the address value.

10. The method of claim 5, wherein the loading of the non-zero element value from the memory includes loading a non-zero element value of a third target matrix from the memory using matrix index information of the third target matrix, and
the transferring of the loaded data to the processing element includes transferring the matrix index information of the first target matrix and the matrix index information of the third target matrix to the processing element.

11. The method of claim 5, wherein the transferring of the loaded data to the processing element includes:
restoring the first target matrix using the matrix index information and the non-zero element value; and
transferring the restored first target matrix to the processing element.

12. The method of claim 5, wherein the transferring of the loaded data to the processing element includes:
comparing the number of the processing elements with the number of the non-zero elements; and
transferring the loaded data to the processing elements according to a result of the comparison.

13. The method of claim 12, wherein the transferring of the loaded data to the processing element includes, when the number of the loaded non-zero element values is less than the number of the processing elements, transferring, to the processing elements, non-zero element values loaded from the memory subsequent to the non-zero element values of the first target matrix together with the non-zero element values of the first target matrix.

14. An apparatus for processing a matrix using matrix index information, the method comprising:
a bit string generator configured to generate at least one bit string including bits each allocated to one of elements of a target matrix and representing position information of the element in the target matrix;
a data loader configured to load a value of a non-zero element among the elements from a memory using the bit string; and
an operator configured to perform an operation on the target matrix using the loaded data.

15. The apparatus of claim 14, wherein the bit string includes:
a first bit string representing information about the number of the non-zero elements; and
a second bit string representing the position information, and
wherein the second bit string includes bits each corresponding to one of positions of the elements in the target matrix.

16. The apparatus of claim 14, wherein the memory is configured to store the bit string of the target matrix and the value of the non-zero element.
